(19) United States
(12) Patent Application Publication
(10) Pub. No.: US 2019/0208939 A1
(43) Pub. Date: Jul. 11, 2019

(54) Utensils and Uses Thereof

(71) Applicant: Theresa D. Heuberger, Goldendale, WA (US)

(72) Inventor: Theresa D. Heuberger, Goldendale, WA (US)

(21) Appl. No.: 16/240,589

(22) Filed: Jan. 4, 2019

Related U.S. Application Data
(60) Provisional application No. 62/614,277, filed on Jan. 5, 2018.

(51) Int. Cl. A47G 21/00

(52) U.S. Cl. CPC A47G 21/00; A47J 43/283

(57) ABSTRACT

Provided herein are utensils. Also provided herein are methods of using the utensils provided herein. Also provided herein are articles of manufacture comprising the utensils provided herein.

### RELATED APPLICATIONS

This application claims priority to U.S. Provisional Patent Application No. 62/614,277, filed Jan. 5, 2018, the entire content of which is incorporated herein by reference.

### SUMMARY

Provided herein are eating utensils comprising: an elongate main body comprising a longitudinal axis, a proximal end, and a distal end; at least three vanes attached to the proximal end; and at least three vanes attached to the distal end.

Also provided herein are methods of transporting a food stuff from a first location to a second location, comprising contacting the proximal end or the distal end of an eating utensil provided herein with the food stuff in the first location such that the food stuff adheres to the proximal end or the distal end of the eating utensil, and subsequently moving the eating utensil to the second location such that the food stuff is transported.

### BRIEF DESCRIPTION OF THE FIGURES

FIG. 1 depicts an embodiment of a conceptual design for a utensil 100.

FIG. 2 depicts a proximal end of utensil 100.

FIG. 3 depicts a distal end of utensil 100.

FIG. 4 depicts an alternate view of utensil 100.

FIG. 5 depicts an alternate view of utensil 100.

FIG. 6 depicts an alternate view of utensil 100.

FIG. 7 depicts an alternate view of utensil 100.

FIG. 8 depicts an embodiment of a conceptual design for a utensil 200.

FIG. 9 depicts a proximal end of utensil 200.

FIG. 10 depicts a distal end of utensil 200.

FIG. 11 depicts an alternate view of utensil 200.

FIG. 12 depicts an alternate view of utensil 200.

### DETAILED DESCRIPTION

Utensils are widely used for transporting a food stuff from a first location to a second location (e.g., from a food stuff container to a subject's mouth). However, some subjects experience difficulty in performing this transport of the food stuff using traditional utensils (e.g., a spoon or fork) without loss of the food stuff during transport. The insufficient utensils result in general frustration on the part of the subject for an inability to transport the food stuff in a desirable manner (e.g., to feed). Additionally, when a subject is unable to timely transport the food stuff as needed in an independent manner, a second subject is often required to assist or to take over performing the required task. The assistant may not be perpetually on-hand, which further contributes to the general frustration of the subject. Furthermore, the use of a second subject to assist in transporting the food stuff may excessively draw on the second subject's limited resources (e.g., time, physical endurance, emotional support, etc.).

Accordingly, there is a continued need to provide utensils and to enable subjects, some of whom may experience difficulty in transporting a food stuff, to transport the food stuff with the utensils in a useful way.

Provided herein are utensils (e.g., eating utensils). Also provided herein are methods of using the utensils provided herein. Two configurations are described, though these are not intended to be limiting.

The first is a utensil having six vanes on the proximal end of the utensil and six vanes on the distal end of the utensil. The second configuration is a utensil having twelve vanes on the proximal end of the utensil and twelve vanes on the distal end of the utensil.

The choice of either configuration, or both, and the design, i.e. the number of vanes in either configuration independently at either the proximal or distal end, is determined by considering the consistency (e.g., viscosity), density, or size of food stuff or food stuff pieces against the distance between adjacent vanes, by considering the varied plasticity (e.g., flexibility) of the vanes in view of the characteristics of the food stuff or food stuff pieces, or by considering both. A number of configurations are possible incorporating the permutations of, at least, the number of vanes independently at each end of a utensil as well as the varied plasticity of the vanes.

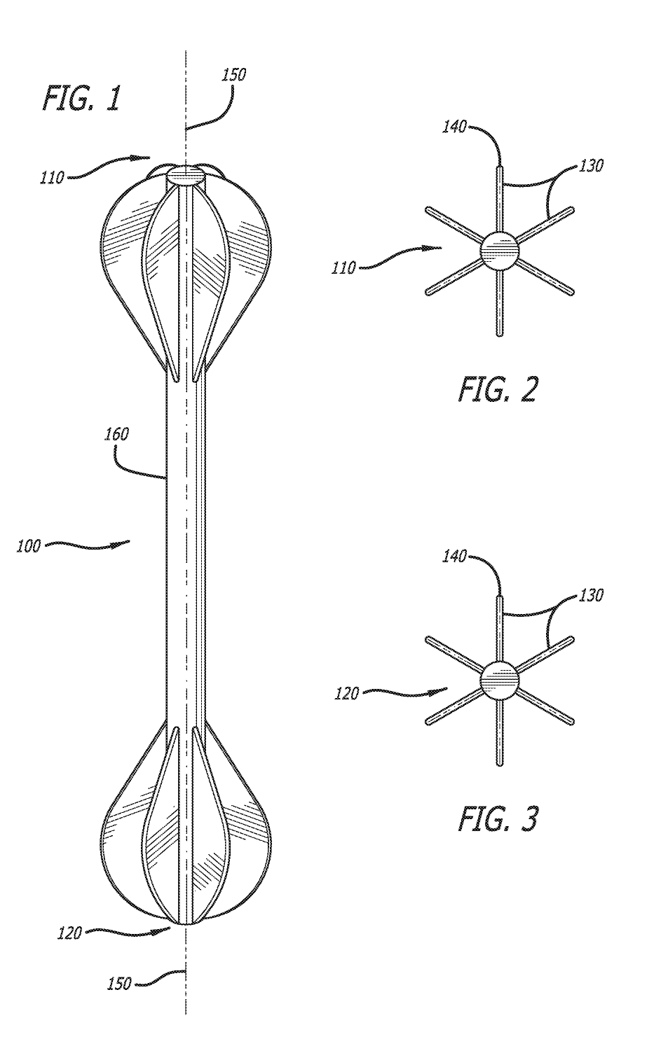

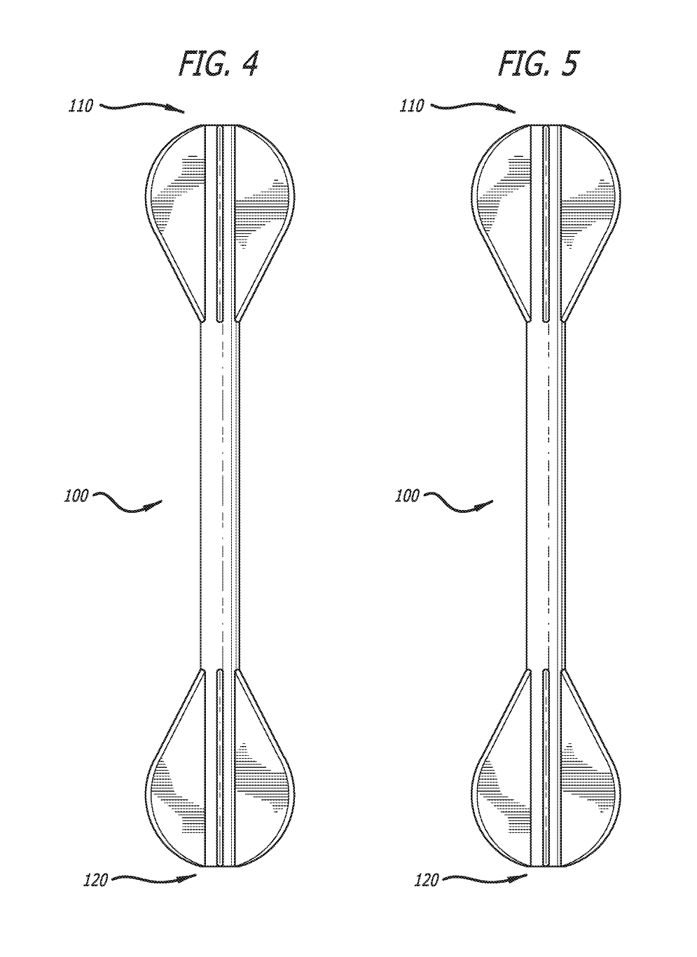

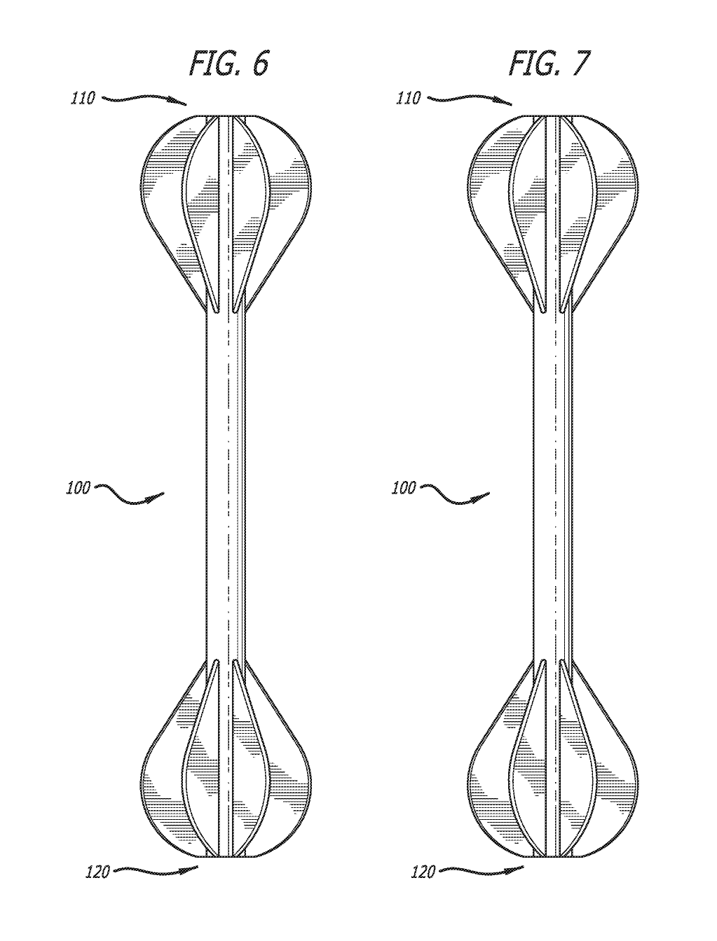

In one embodiment, a utensil 100 is shown in the various perspectives of FIGS. 1-7. A food stuff (not shown) contacts proximal end 110 or distal end 120, and adheres to, between, or to and between, a surface or surfaces 130 of the vanes 140. The utensil 100 comprises a longitudinal axis 150, as well as a elongate main body 160 linking the proximal end 110 and the distal end 120.

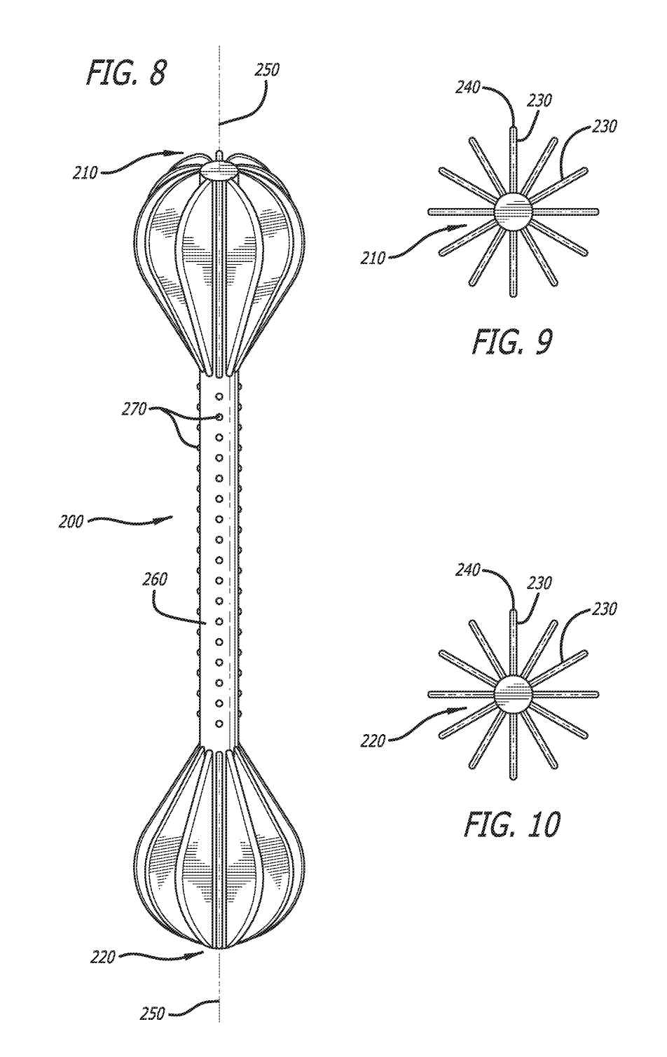

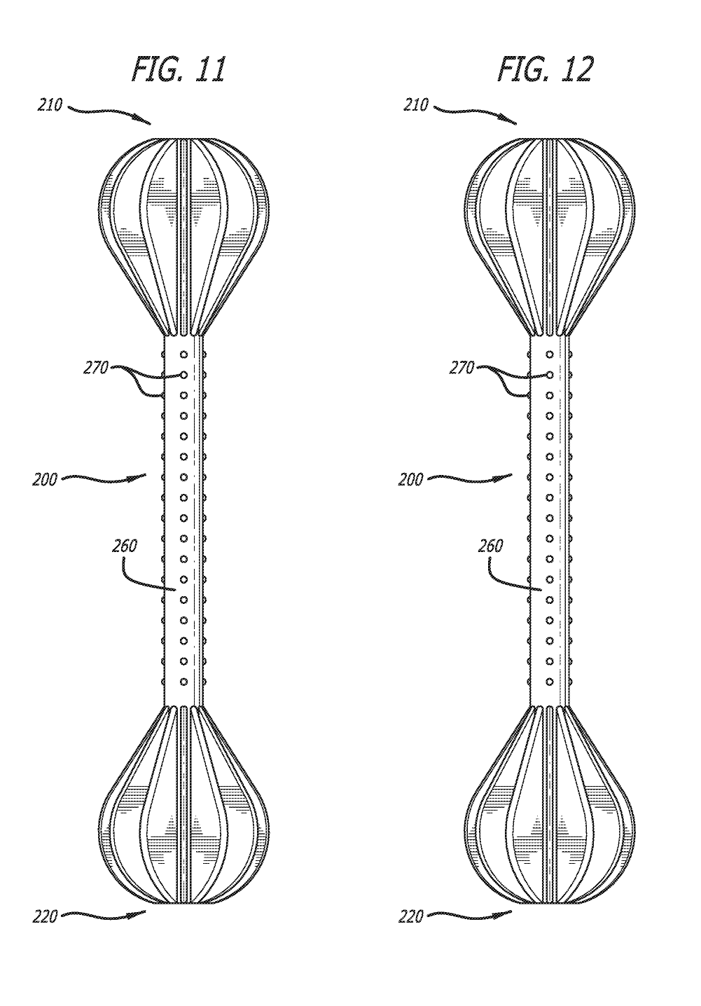

In another embodiment, a utensil 200 is shown in the various perspectives of FIGS. 8-12. A food stuff (not shown) contacts proximal end 210 or distal end 220, and adheres to, between, or to and between, a surface or surfaces 230 of the vanes 240. The utensil 200 comprises a longitudinal axis 250, as well as an elongate main body 260 linking the proximal end 210 and the distal end 220. The elongate main body 260 comprises raised bumps, or studs, 270 to facilitate suitable gripping or prevention of slippage while a subject (not shown) holds the utensil 200.

In one aspect, provided herein are eating utensils comprising: an elongate main body comprising a longitudinal axis, a proximal end, and a distal end; and at least three vanes attached to the proximal end, or at least three vanes attached to the distal end.

In some embodiments, the eating utensils comprise at least three vanes attached to the proximal end, and at least three vanes attached to the distal end.

In some embodiments, the eating utensils provided herein comprise: three to twelve vanes attached to the proximal end; three to twelve vanes attached to the distal end; or three to twelve vanes attached to the proximal end, and three to twelve vanes attached to the distal end.

In some embodiments, the number of vanes attached to the proximal end is different than the number of vanes attached to the distal end.

In some embodiments, the number of vanes attached to the proximal end is the same as the number of vanes attached to the distal end.

In some embodiments, the number of vanes attached to the proximal end is 3, 4, 5, 6, 7, 8, 9, 10, 11, or 12 vanes, or any range between any two of these values. In some embodiments, the number of vanes attached to the proximal end is 3, 4, 5, 6, or 7 vanes. In some embodiments, the number of vanes attached to the proximal end is 4, 5, or 6 vanes. In some embodiments, the number of vanes attached to the proximal end is 5, 6, or 7 vanes. In some embodiments, the number of vanes attached to the proximal end is 3 vanes. In some embodiments, the number of vanes attached to the proximal end is 4 vanes. In some embodiments, the number of vanes attached to the proximal end is 5 vanes. In some embodiments, the number of vanes attached to the proximal end is 6 vanes. In some embodiments, the number of vanes attached to the proximal end is 7 vanes. In some embodiments, the number of vanes attached to the proximal end is 8 vanes. In some embodiments, the number of vanes attached to the proximal end is 9 vanes. In some embodiments, the number of vanes attached to the proximal end is 10 vanes. In some embodiments, the number of vanes attached to the proximal end is 11 vanes. In some embodiments, the number of vanes attached to the proximal end is 12 vanes.

In some embodiments, the number of vanes attached to the distal end is 3, 4, 5, 6, 7, 8, 9, 10, 11, or 12 vanes, or any range between any two of these values. In some embodiments, the number of vanes attached to the distal end is 3, 4, 5, 6, or 7 vanes. In some embodiments, the number of vanes attached to the distal end is 4, 5, or 6 vanes. In some embodiments, the number of vanes attached to the distal end is 5, 6, or 7 vanes. In some embodiments, the number of vanes attached to the distal end is 3 vanes. In some embodiments, the number of vanes attached to the distal end is 4 vanes. In some embodiments, the number of vanes attached to the distal end is 5 vanes. In some embodiments, the number of vanes attached to the distal end is 6 vanes. In some embodiments, the number of vanes attached to the distal end is 7 vanes. In some embodiments, the number of vanes attached to the distal end is 8 vanes. In some embodiments, the number of vanes attached to the distal end is 9 vanes. In some embodiments, the number of vanes attached to the distal end is 10 vanes. In some embodiments, the number of vanes attached to the distal end is 11 vanes. In some embodiments, the number of vanes attached to the distal end is 12 vanes.

In some embodiments, the eating utensils provided herein comprise six vanes attached to the proximal end, and six vanes attached to the distal end.

In some embodiments, the vanes attached to the proximal end are evenly distributed circumferentially about the longitudinal axis, the vanes attached to the distal end are evenly distributed circumferentially about the longitudinal axis, or the vanes attached to the proximal end are evenly distributed circumferentially about the longitudinal axis, and the vanes attached to the distal end are evenly distributed circumferentially about the longitudinal axis.

In some embodiments, the vanes attached to the proximal end are evenly distributed circumferentially about the longitudinal axis, and the vanes attached to the distal end are evenly distributed circumferentially about the longitudinal axis.

In some embodiments, the elongate main body comprises a first surface, the first surface being textured on at least a portion of the surface to improve handling of the utensil.

In some embodiments, the eating utensils provided herein comprise six vanes attached to the proximal end, and six vanes attached to the distal end, wherein: the vanes attached to the proximal end are evenly distributed circumferentially about the longitudinal axis, and the vanes attached to the distal end are evenly distributed circumferentially about the longitudinal axis; and the elongate main body comprises a first surface, the first surface being textured on at least a portion of the surface to improve handling of the utensil.

In some embodiments, the vanes are flexible.

In some embodiments, the vanes are comprised of a food contact substance having an elastic limit that is not exceeded upon compression of a lip, two lips, a gum of a mouth, two gums of a mouth, or a tongue of a subject upon or about the vanes. In some embodiments, the vanes are comprised of a food contact substance having an elastic limit that is not exceeded upon compression of a lip, two lips, or a tongue of a subject upon or about the vanes. In some embodiments, the gum or two gums of the mouth do not have exposed teeth.

In some embodiments, the vanes are formed of a food contact substance that will not harm a subject eating therefrom.

In some embodiments, the eating utensil comprises one or more (e.g., 1, 2, 3, 4, 5, 6, 7, 8, 9, or 10 or more, or a range bounded by any two of these values) food contact substances.

In some embodiments, one or more food contact substances are independently disposed throughout the surface of the proximal end and the proximal vanes.

In some embodiments, one or more food contact substances are independently disposed throughout the surface of the distal end and the distal vanes.

In some embodiments, one or more food contact substances are independently disposed throughout the surface of the elongate main body.

In some embodiments, the eating utensil is made of one or more food contact substances independently disposed throughout the eating utensil.

In some embodiments, the food contact substance is, independently, a plastic substance, a metal substance, a paper substance, a wood substance, a porcelain substance, a glass substance, or a combination thereof. In some embodiments, the food contact substance is a plastic substance.

In some embodiments, the food contact substance is suitable to withstand the environment (e.g., temperature, pressure, detergent) of an automatic dishwasher without being deformed (e.g., without being substantially deformed).

In some embodiments, the utensil is suitable to be washed in an upper rack of an automatic dishwasher (e.g., upper rack safe).

In some embodiments, the utensil is suitable to be washed in a lower rack of an automatic dishwasher (e.g., lower rack safe).

In some embodiments, the utensil is suitable to be washed in a utensil tray of an automatic dishwasher.

In some embodiments, the utensil is suitable to be washed by hand.

In some embodiments, the vanes have a non-sharp edge.

In some embodiments, the vanes have edges that are rounded.

In some embodiments, the vanes on the proximal end are evenly distributed circumferentially about the longitudinal axis.

In some embodiments, the vanes on the proximal end are not evenly distributed circumferentially about the longitudinal axis.

In some embodiments, the vanes on the distal end are evenly distributed circumferentially about the longitudinal axis.

In some embodiments, the vanes on the distal end are not evenly distributed circumferentially about the longitudinal axis.

In some embodiments, a first pair of two adjacent vanes on an end of the utensil define a first angle, and a second pair of two adjacent vanes on an end of the utensil define a second angle, wherein the first angle and the second angle are the same or different. In some embodiments the first pair of two adjacent vanes is not on the same end of the utensil as the second pair of two adjacent vanes. In some embodiments the first pair of two adjacent vanes is on the same end of the utensil as the second pair of two adjacent vanes.

In some embodiments, the vanes, independently, have a profile tangent to the longitudinal axis that is curvilinear, geometric, or a combination thereof.

In some embodiments, the vanes, independently, have a teardrop profile, a curvilinear profile, or a polygonal profile.

In some embodiments, the vanes, independently, have a teardrop profile.

In some embodiments, the vanes, independently, have a curvilinear profile.

In some embodiments, the vanes, independently, have a polygonal profile.

In some embodiments, each vane, independently, has a central plane through which the longitudinal axis passes.

In some embodiments, each vane, independently, has a central plane through which the longitudinal axis intersects.

In some embodiments, the vanes, independently, are helically oriented about the longitudinal axis.

In some embodiment, the elongate main body has a cross section that is a geometric shape. In some embodiments, the elongate main body has one or more cross sections that are, independently, a geometric shape.

In some embodiments, the cross section is, independently, a curvilinear cross section, a geometric shape, or a combination thereof.

In some embodiments, the geometric shape is, independently, circular, oval, elliptical, polygonal.

In some embodiments, the geometric shape is triangular, rectangular, pentagonal, hexagonal, heptagonal, or octagonal.

In some embodiments, the geometric shape is, independently, a geometric shape having N sides, wherein N is 3, 4, 5, 6, 7, 8, 9, 10, or 11 or more. In some embodiments, N is 3, 4, 5, or 6. In some embodiments, N is 3. In some embodiments, N is 4. In some embodiments, N is 5. In some embodiments, N is 6. In some embodiments, N is 7. In some embodiments, N is 8.

### Articles of Manufacture

In one aspect, provided herein are articles of manufacture comprising a utensil provided herein.

In some embodiments, the article of manufacture comprises a packaging material.

In some embodiments, the article of manufacture comprises instructions for use of the utensil. In some embodiments, the instructions include instructions for care (e.g., washing) of the utensil.

In some embodiments, the article of manufacture comprises more than one utensil provided herein (e.g., 2, 3, 4, 5, 6, 7, 8, 9, or 10 or more, or a range bounded by any two of these values). In some embodiments, the article of manufacture comprises about 200 or less of the utensils provided herein (e.g., about 200, 190, 180, 170, 160, 150, 140, 130, 120, 110, 100, 90, 80, 70, 60, 50, 40, 30, 20, or 10 or less, or a range bounded by any two of these values).

Methods

In one aspect, provided herein are methods of transporting a food stuff from a first location to a second location, comprising contacting the proximal end or the distal end of an eating utensil provided herein with the food stuff in the first location such that the food stuff adheres to the proximal end or the distal end of the eating utensil, and subsequently transporting the eating utensil to the second location such that the food stuff is transported.

In some embodiments, the food stuff is substantially retained on the proximal end or the distal end of the eating utensil during transportation of the eating utensil.

In another aspect, provided herein are methods of transporting a first fraction of a first amount of a food stuff from a first location to a second location, comprising contacting the proximal end or the distal end of an eating utensil provided herein with a food stuff in the first location such that the first amount of the food stuff adheres to the proximal end or the distal end of the eating utensil, and subsequently transporting the eating utensil to the second location, wherein a second fraction of the first amount of a food stuff does not adhere to the proximal end or distal end of the eating utensil during transportation, such that the first fraction of the first amount of the food stuff is transported.

In some embodiments, the first fraction of the first amount of the food stuff is about 1% or more. In some embodiments, the first fraction of the first amount of the food stuff is about 5% or more. In some embodiments, the first fraction of the first amount of the food stuff is about 10% or more. In some embodiments, the first fraction of the first amount of the food stuff is about 15% or more. In some embodiments, the first fraction of the first amount of the food stuff is about 20% or more. In some embodiments, the first fraction of the first amount of the food stuff is about 30% or more. In some embodiments, the first fraction of the first amount of the food stuff is about 40% or more. In some embodiments, the first fraction of the first amount of the food stuff is about 50% or more. In some embodiments, the first fraction of the first amount of the food stuff is about 60% or more. In some embodiments, the first fraction of the first amount of the food stuff is about 70% or more. In some embodiments, the first fraction of the first amount of the food stuff is about 80% or more. In some embodiments, the first fraction of the first amount of the food stuff is about 90% or more. In some embodiments, the first fraction of the first amount of the food stuff is about 95% or more. In some embodiments, the first fraction of the first amount of the food stuff is about 99% or more. In some embodiments, the first fraction of the first amount of the food stuff is about 100%.

In some embodiments, the second fraction of the first amount of the food stuff is about 0%. In some embodiments, the second fraction of the first amount of the food stuff is about 1% or less. In some embodiments, the second fraction of the first amount of the food stuff is about 5% or less. In some embodiments, the second fraction of the first amount of the food stuff is about 10% or less. In some embodiments, the second fraction of the first amount of the food stuff is about 15% or less. In some embodiments, the second fraction of the first amount of the food stuff is about 20% or less. In some embodiments, the second fraction of the first amount of the food stuff is about 30% or less. In some embodiments, the second fraction of the first amount of the food stuff is about 40% or less. In some embodiments, the second fraction of the first amount of the food stuff is about 50% or less. In some embodiments, the second fraction of the first amount of the food stuff is about 60% or less. In some embodiments, the second fraction of the first amount of the food stuff is about 70% or less. In some embodiments, the second fraction of the first amount of the food stuff is about 80% or less. In some embodiments, second first fraction of the first amount of the food stuff is about 90% or less. In some embodiments, the second fraction of the first amount of the food stuff is about 95% or less. In some embodiments, the second fraction of the first amount of the food stuff is about 99% or less.

### EXAMPLES

### Example 1: Child Feeding

A child (e.g., an infant or toddler) picks up a utensil provided herein. A container of purée is placed in front of the child. The child dredges an end of the utensil through the purée and brings the end to their mouth. The child then places the utensil having an amount of purée adhering to the end of the utensil into their mouth and articulates their mouth and lips such that an amount of the purée is retained in their mouth upon removal of the utensil end from their mouth. The child swallows the purée. The child iterates the feeding process as needed, to satiation, or to distraction.

### Example 2: Subject with Disability (e.g., Suffering from a Medical Condition) Feeding

A subject picks up a utensil provided herein. A container of purée is placed in front of the subject. The subject dredges an end of the utensil through the purée and brings the end to the subject's mouth. The subject then places the utensil having an amount of purée adhering to the end of the utensil into their mouth and articulates their mouth and lips such that an amount of the purée is retained in their mouth upon removal of the utensil end from their mouth. The subject swallows the purée. The subject iterates the feeding process as needed, to satiation, or to distraction.

In some embodiments of the methods described herein, the subject suffers from a motor neuron disease (e.g., amyotrophic lateral sclerosis (ALS), progressive bulbar palsy (PBP), pseudobulbar palsy, progressive muscular atrophy (PMA), primary lateral sclerosis (PLS), and monomelic amyotrophy (MMA)), Parkinson disease, tremors (e.g., limb tremors, hand tremors, or finger tremors), bradykinsesia, Bell's palsy, carpal tunnel syndrome, peripheral neuropathy, Guillain-Barré syndrome, neuralgia, multiple sclerosis, Huntington chorea, or Alzheimer disease.

Unless otherwise defined, all technical and scientific terms used herein are accorded the meaning commonly known to one with ordinary skill in the art.

Those skilled in the art will recognize, or be able to ascertain using no more than routine experimentation, many equivalents of the specific embodiments provided herein. Such equivalents are intended to be encompassed by the following claims.

1. An eating utensil comprising:
an elongate main body comprising a longitudinal axis, a proximal end, and a distal end; and
at least three vanes attached to the proximal end, or at least three vanes attached to the distal end.

2. The eating utensil of claim 1, comprising:
three to twelve vanes attached to the proximal end;
three to twelve vanes attached to the distal end; or
three to twelve vanes attached to the proximal end, and three to twelve vanes attached to the distal end.

3. The eating utensil of claim 1, comprising six vanes attached to the proximal end, and six vanes attached to the distal end.

4. The eating utensil of claim 1, wherein:
the vanes attached to the proximal end are evenly distributed circumferentially about the longitudinal axis;
the vanes attached to the distal end are evenly distributed circumferentially about the longitudinal axis; or
the vanes attached to the proximal end are evenly distributed circumferentially about the longitudinal axis, and the vanes attached to the distal end are evenly distributed circumferentially about the longitudinal axis.

5. The eating utensil of claim 1, wherein the vanes attached to the proximal end are evenly distributed circumferentially about the longitudinal axis, and the vanes attached to the distal end are evenly distributed circumferentially about the longitudinal axis.

6. The eating utensil of claim 1, wherein the elongate main body comprises a first surface, the first surface being textured on at least a portion of the surface to improve handling of the utensil.

7. The eating utensil of claim 1, comprising six vanes attached to the proximal end, and six vanes attached to the distal end, wherein:
the vanes attached to the proximal end are evenly distributed circumferentially about the longitudinal axis, and the vanes attached to the distal end are evenly distributed circumferentially about the longitudinal axis; and
the elongate main body comprises a first surface, the first surface being textured on at least a portion of the surface to improve handling of the utensil.

8. The eating utensil of claim 1, wherein the vanes are flexible.

9. The eating utensil of claim 8, wherein the vanes are comprised of a food contact substance having an elastic limit that is not exceed upon compression by a lip, two lips, a gum of a mouth, two gums of the mouth, or a tongue of a subject upon or about the vanes.

10. The eating utensil of claim 1, wherein the eating utensil comprises at least one food contact substance.

11. The eating utensil of claim 10, wherein the at least one food contact substance is, independently, a plastic substance, a metal substance, a paper substance, a wood substance, a porcelain substance, a glass substance, or a combination thereof.

12. A method of transporting a food stuff from a first location to a second location, comprising contacting the proximal end or the distal end of the eating utensil of claim 1 with the food stuff in the first location such that the food stuff adheres to the proximal end or the distal end of the eating utensil, and subsequently moving the eating utensil to the second location such that the food stuff is transported.

13. The method of claim 12, wherein the food stuff is substantially retained on the proximal end or the distal end of the eating utensil during transportation of the eating utensil.

14. An article of manufacture comprising one or more eating utensils of claim 1.

15. The article of manufacture of claim 14, wherein the article of manufacture further comprises a packaging material.

16. The article of manufacture of claim 14, wherein the article of manufacture further comprises instructions for use of the utensil.

17. The article of manufacture of claim 14, wherein the article of manufacture comprises more than one of the eating utensils.

18. The article of manufacture of claim 17, wherein the article of manufacture comprises 2, 3, 4, 5, 6, 7, 8, 9, or 10 or more of the eating utensils.

19. The article of manufacture of claim 17, wherein the article of manufacture comprises about 200 or less of the eating utensils.

20. A method of transporting a first fraction of a first amount of a food stuff from a first location to a second location, comprising contacting the proximal end or the distal end of an eating utensil of claim 1 with a food stuff in the first location such that the first amount of the food stuff adheres to the proximal end or the distal end of the eating utensil, and subsequently transporting the eating utensil to the second location, wherein a second fraction of the first amount of a food stuff does not adhere to the proximal end or distal end of the eating utensil during transportation, such that the first fraction of the first amount of the food stuff is transported.
